(19) United States
(12) Patent Application Publication
(10) Pub. No.: US 2019/0141462 A1
(43) Pub. Date: May 9, 2019

(54) SYSTEM AND METHOD FOR PERFORMING AN AUDIOMETRIC TEST AND CALIBRATING A HEARING AID

(71) Applicant: Andrea VELATI, Padova (IT)

(72) Inventor: Andrea VELATI, Padova (IT)

(21) Appl. No.: 15/807,868

(22) Filed: Nov. 9, 2017

(51) Int. Cl. H04R 25/00

(52) U.S. Cl. CPC H04R 25/70; H04R 25/30

(57) ABSTRACT

A system for performing an audiometric test and calibrating a hearing aid includes an audio playback component, a selection component, and a wireless communication module. The system also includes an audiometric group having a system volume setting module configured to set the volume of the system according to corresponding commands given by the user, and an audiometric test module configured to perform an audiometric test of the user hearing, sending a sequence of tones. The system further includes a hearing aid management group with a hearing aid settings calibration module configured to calibrate settings of the hearing aid according to both the results of the performed audiometric test and the requirements and specifications of fitting of the hearing aid.

### TECHNICAL FIELD

The present disclosure relates generally to audiometric testing systems and to methods for calibrating hearing aids. Particularly, the present disclosure relates to a system and a method for performing independently an audiometric test and for calibrating automatically a hearing aid, based on the audiometric test results.

### BACKGROUND

According to most recent statistics, about 10% of the world's population suffers from hypoacusis or hearing loss, in particular sensorineural hearing loss (SNHL).

Various hearing aids are known, for example digital hearing aids. A hearing aid is a device designed to improve hearing, for example highlighting a spatial region, shifting frequencies, cancelling noise and wind, or highlighting voice. Modern hearing aids are computerized electroacoustic systems that transform environmental sound to make it more intelligible or comfortable, according to audiometrical and cognitive rules.

Modern hearing aids require configuration to match the hearing loss of the person. This configuration process is commonly called “fitting” and is performed by audiologists.

The hearing aid configuration is performed by the audiologist based on the results of an audiometric test of the person hearing. Audiometers and audiometric testing techniques are well known. For example, threshold bracketing techniques are utilized to determine a person's hearing thresholds at various frequencies by incrementing or decrementing the intensity of a test tone applied to one of the person's ears until he/she satisfactorily indicates that he/she has heard the test tone.

There exist audiometric test systems and methods for testing person's hearing to determine threshold levels at various frequencies, automatically computing audiometric parameters from such threshold levels, automatically determining the presence of any significant threshold level shifts of the subject by comparing the subject's present test results with the prior test results, and automatically indicating the presence of any significant threshold level shifts.

Unfortunately, only a small portion of the population who suffers hearing loss wears hearing aids, for various reasons. The most common reason is the high cost of the hearing aids themselves.

In order to overcome this poor market penetration of the hearing aids, low-cost hearing aids have recently been released. However, the main weakness of these low-cost hearing aids is that they are pre-configured, i.e. they have standard amplifications, not calibrated on the actual hearing loss of the person. This implies that only a small portion of the people wearing these low-cost hearing aids use them with satisfaction, since it is not possible to customize the frequency response, which is actually performed by audiologists. Nevertheless, low cost often leads to the purchase of these conventional hearing aids.

### SUMMARY

The aim of the present disclosure is to provide a system and a method for performing an audiometric test and calibrating a hearing aid that are capable of improving the background art in one or more of the aspects indicated above.

Within the scope of this aim, the disclosure provides a system and a method for performing an audiometric test and calibrating a hearing aid that allow the user to perform independently and simply a reliable audiometric test, without the intervention of an audiometrist or, more in general, a hearing clinician.

In particular, this disclosure provides a system and a method for performing an audiometric test and calibrating a hearing aid that permit the user to configure and calibrate automatically a hearing aid, based on the audiometric test results, without the intervention of an audiologist.

Moreover, the present disclosure provides a system and a method for performing an audiometric test and calibrating a hearing aid that allow the user to adjust over time the calibration of the hearing aid settings, for example in case of hearing loss change or for improving the listening of the user.

The present disclosure also provides a system and a method for performing an audiometric test and calibrating a hearing aid that permit the user to obtain a customized hearing aid in a completely independent manner

The present disclosure further provides a system and a method for performing an audiometric test and calibrating a hearing aid that are highly reliable, relatively easy to manufacture and at competitive costs.

This aim, as well as these and other advantages that will become better apparent hereinafter, are achieved by providing a system for performing an audiometric test and calibrating a hearing aid, the system being operated by a user and in communication with a hearing aid, the system comprising: audio playback means, selection means, and a wireless communication module; an audiometric group, the audiometric group comprising: a system volume setting module configured to set the volume of the system according to corresponding commands given by the user, through the selection means, and an audiometric test module configured to perform an audiometric test of the user hearing, sending a sequence of tones, through the audio playback means; and a hearing aid management group, the hearing aid management group comprising: a hearing aid settings calibration module configured to calibrate settings of the hearing aid according to both the results of the performed audiometric test and the requirements and specifications of fitting of the hearing aid, calibration data being sent through the wireless communication module to a corresponding wireless communication module comprised in the hearing aid.

This aim and these advantages are also achieved by providing a method for performing an audiometric test and calibrating a hearing aid, having a system being operated by a user and in communication with a hearing aid, the method comprising the steps of setting the volume of the system according to corresponding commands given by the user; performing an audiometric test of the user hearing, sending a sequence of tones; and calibrating settings of the hearing aid according to both the results of the performed audiometric test and the requirements and specifications of fitting of the hearing aid.

### BRIEF DESCRIPTION OF THE DRAWINGS

The foregoing, as well as further characteristics and advantages of the present disclosure, will become better apparent to those skilled in the art from the following description of a preferred, but not exclusive, embodiment of the system and method for performing an audiometric test and calibrating a hearing aid according to the disclosure, illustrated by way of non-limiting example in the accompanying drawings, wherein:

FIG. 1 is a block diagram schematically illustrating an embodiment of the system for performing an audiometric test and calibrating a hearing aid, according to the present disclosure;

FIG. 2 is a block diagram schematically illustrating a first detail of the embodiment of the system for performing an audiometric test and calibrating a hearing aid shown in FIG. 1, according to the present disclosure;

FIG. 3 is a block diagram schematically illustrating a second detail of the embodiment of the system for performing an audiometric test and calibrating a hearing aid shown in FIG. 1, according to the present disclosure; and

FIG. 4 is a flow chart schematically illustrating an embodiment of the method for performing an audiometric test and calibrating a hearing aid, according to the present disclosure.

### DETAILED DESCRIPTION OF THE DISCLOSURE

The following detailed description and appended figures describe and illustrate an exemplary embodiment of the disclosure. The description and figures serve to enable one skilled in the art to make and use the disclosure, and are not intended to limit the present disclosure, and its applications or uses. It should also be understood that throughout the figures, corresponding reference numerals indicate like or corresponding parts and features.

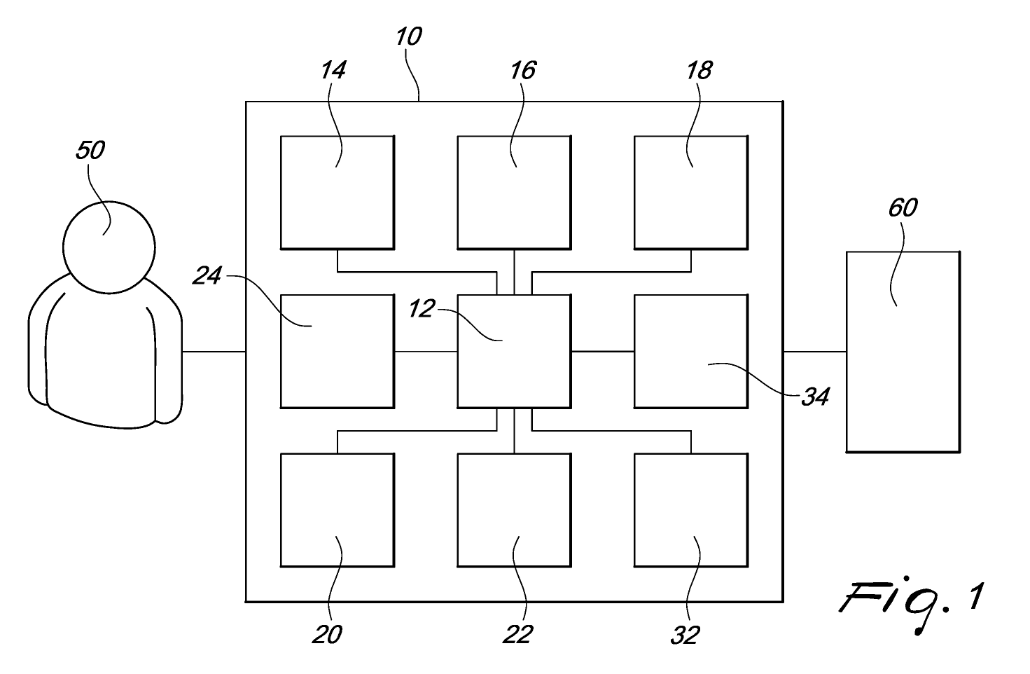

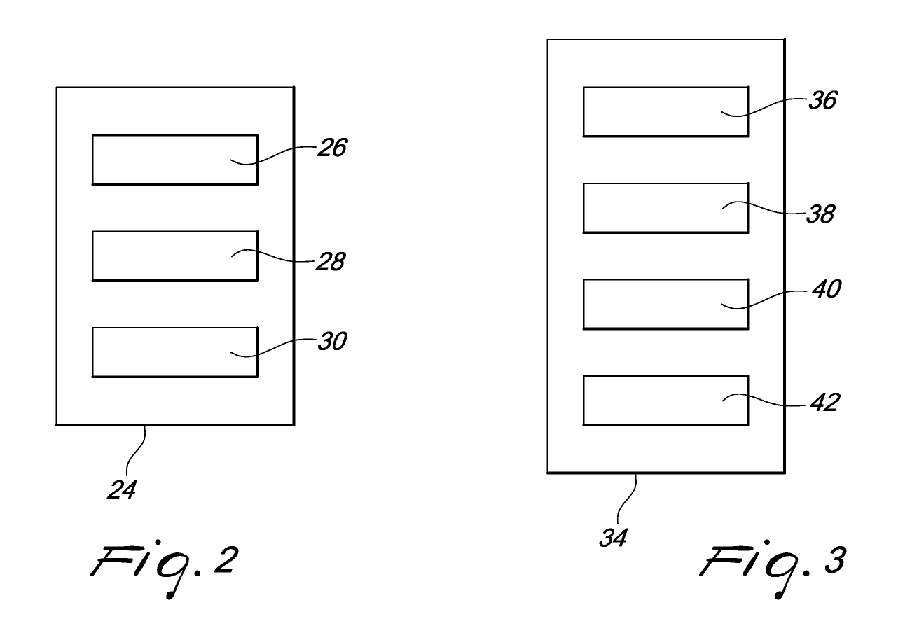

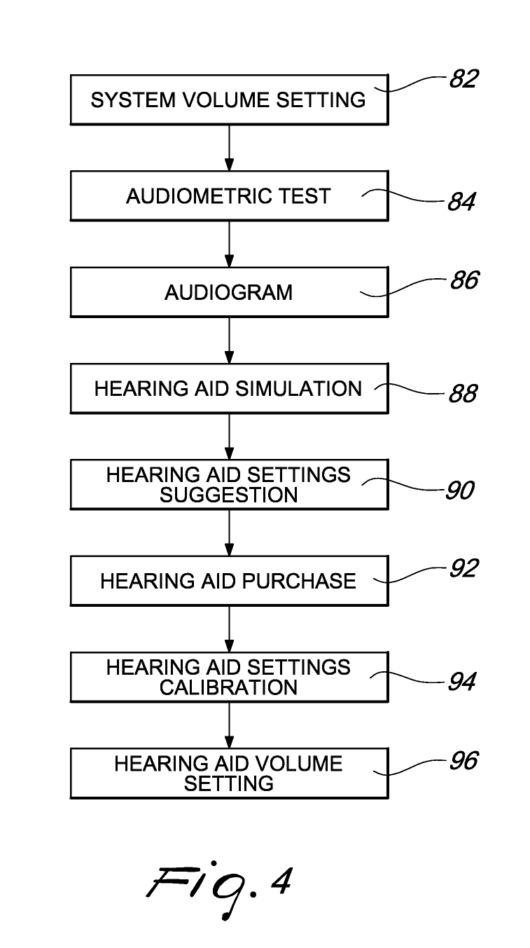

A system for performing an audiometric test and calibrating a hearing aid, generally designated by the reference numeral 10, is described below with reference to the FIGS. 1-4.

The system 10 is operated by a user 50, which is typically also the person who suffers from hearing loss. The system 10 interfaces with a hearing aid 60. The system 10 is in communication with a hearing aid 60.

The system 10 comprises a central processing unit or CPU 12. The CPU 12 is the main functional element of the system 10, and for this reason it is connected and in communication with the other elements comprised in the same system 10.

The CPU 12 has suitable computing capabilities and interfacing capabilities with the other elements of the system 10. The CPU 12 is configured to command, control and coordinate the operation of the elements of the system 10 with which it is connected and in communication, for example in order to subject a user 50 to an audiometric test or to calibrate the settings of the hearing aid 60.

The system 10 comprises audio or acoustic playback means 14, preferably headphones but also a speaker or a device configured to transform an electric signal in sound waves. The audio playback means 14 serve to emit or send sound signals to the user 50. For example, the audio playback means 14 serve to sends a sequence of tones to the user 50 during an audiometric test, or as output sound source for the simulation of a virtual hearing aid.

The system 10 comprises audio or acoustic acquisition means 16, preferably a microphone but also a device configured to transform sound waves in an electric signal. The audio acquisition means 16 serve to receive sound signals from the user 50 or from the environment. For example, the audio acquisition means 16 serve as input sound source for the simulation of a virtual hearing aid.

The system 10 comprises display means 18, preferably a screen. The display means 18 serve to show data, information and the like to the user 50. For example, the display means 18 serve to visually signal to the user 50 each time a tone is sent during an audiometric test, to visually signals to the user 50 when the sequence of tones for the first ear has been sent and it is time to move to the second ear, to show to the user 50 an audiogram or audiometric curve, or to show to the user 50 a value or a color that identify a suggested setting for the calibration of the hearing aid 60.

The system 10 comprises selection means 20, preferably a touch-screen but also a keyboard or a set of buttons. The selection means 20 serve to detect commands from the user 50. For example, the selection means 20 serve to detect commands given by the user 50 to set the volume of the system 10, to detect a “start” command given by the user 50 to launch an audiometric test, to detect a confirmation command if he/she hears each of the tones during an audiometric test, or to detect commands given by the user 50 to set the volume of the hearing aid 60.

The system 10 comprises a local data storage 22. The local data storage 22 serves to store or save data, information and the like related to the system 10. For example, the local data storage 22 serves to save the results of a performed audiometric test, comprising the user feedbacks or responses, or to save data of each calibration.

The system 10 comprises a wireless communication module 32, preferably of Bluetooth type. The wireless communication module 32 serves to establish a wireless communication between the system 10 and the hearing aid 60. For example, the wireless communication module 32 serves to send calibration data from the system 10 to the hearing aid 60, comprising a corresponding wireless communication module.

Furthermore, the system 10 for performing an audiometric test and calibrating a hearing aid comprises an audiometric group 24 and a hearing aid management group 34.

The audiometric group 24 comprises a system volume setting module 26. The system volume setting module 26 is configured to set the volume of the system 10 according to corresponding commands given by the user 50 through the selection means 20. Preferably, the volume of the system 10 is expressed in dB HL (decibels Hearing Level), a measuring unit of sound intensity that defines to zero the minimum sound pressure value audible to all frequencies.

The audiometric group 24 comprises an audiometric test module 28. The audiometric test module 28 is configured to perform an audiometric test of the user hearing, for example following a “start” command given by the user 50 through the selection means 20. The audiometric test is performed independently by the system 10 operated by the user 50, i.e. without the intervention of an audiometrist or, more in general, a hearing clinician.

In particular, the audiometric test module 28 sends a sequence of tones through the audio playback means 14, and the user 50 only has to indicate if he/she hears each of these tones through the selection means 20: for example, touching a “yes” or “I hear” button (tone heard) or a “no” or “I don't hear” button (tone not heard). In a preferred embodiment, the sequence of tones counts five tone frequencies for each ear: 250 Hz, 500 Hz, 1000 Hz, 2000 Hz, and 4000 Hz.

Once the audiometric test of the user 50 is completed, the audiometric test module 28 saves the results of the performed audiometric test, comprising the user feedbacks or responses, in the local data storage 22. In an embodiment, the audiometric test module 28 saves the results of the performed audiometric test also in a remote data storage, preferably subject to authorization by the user 50.

In an embodiment, the audiometric test module 28 visually signals to the user 50, through the display means 18, each time a tone is sent. In an embodiment, the audiometric test module 28 visually signals to the user 50, through the display means 18, when the sequence of tones for the first ear has been sent and it is time to move to the second ear.

In a preferred embodiment, the audiometric test module 28 sends the tones to the user 50 (i.e. the listener) following a sequence defined by a predictive algorithm, in order to reduce the duration of the audiometric test by processing user feedbacks or responses. The sequence of tones is defined by a predictive algorithm The predictive algorithm is based on a psychometric function as follows.

Function response=listener (soundlevel, alpha, beta, gamma, lambda);

wherein:
soundlevel is the value of sound intensity of the tone sent, expressed in dB;
alpha is the personal threshold value of the listener, expressed in dB, i.e. the value of sound intensity to which the listener answers “yes” or “I hear” 50% of the times;
beta is the slope of the psychometric function of the virtual listener;
gamma is a probability representing the possible tendency of the listener to produce false alarms: for example, gamma equal to 0 in order to set a listener without any false alarms;
lambda is a probability representing the possible tendency of the listener to produce attention decreases: for example, lambda equal to 0 in order to set a listener without any attention decreases.

Psychometric function of the observer:

p=gamma+(1−gamma−lambda)*1/(1+exp(beta*(alpha−soundlevel)));

Prediction of the listener response:

prob=rand;

if prob<p then response=1; yes;

else response=0; no;

end;

Note that the above functions are calculated assuming consistent and coherent user/listener feedbacks or responses.

In an embodiment, the audiometric group 24 further comprises an audiogram module 30. The audiogram module 30 is configured to show to the user 50 an audiogram or audiometric curve, through the display means 18. Preferably, the audiogram is shown in real time, i.e. during the performance of the audiometric test. The audiogram is a graphical representation of a person's hearing ability for each ear, indicating the degree and type of hearing loss. In practice, the visualization of the audiogram allows the user 50 to immediately feel his/her level of hearing loss.

The hearing aid management group 34 comprises a hearing aid settings calibration module 36. The hearing aid settings calibration module 36 is configured to calibrate various settings of the hearing aid 60, typically worn by the user 50, according to both the results of the performed audiometric test, i.e. the user' s hearing loss previously measured by the audiometric test, and the requirements and specifications of hearing aid fitting provided by the manufacturer of the same hearing aid 60.

In an embodiment, the settings of the hearing aid 60 comprises the frequency response curve, the frequencies (for example 500 Hz, 1000 Hz, 2000 Hz, 3000 Hz, and 4000 Hz) and the sound intensity for each frequency expressed in dB HL (for example within a range from 0 to 90).

As mentioned, the hearing aid settings are calibrated according to the user's hearing loss previously measured by the audiometric test, in order to amplify only the frequencies at which the hearing loss occurs.

The calibration of the hearing aid 60 is performed through the wireless communication module 32. Calibration data are sent through the wireless communication module 32 to a corresponding wireless communication module comprised in the hearing aid 60.

The calibration of the hearing aid settings can be adjusted over time, for example in case of hearing loss change or for improving the listening of the user 50. Data of each calibration are saved in the local data storage 22.

In an embodiment, the hearing aid management group 34 further comprises a hearing aid simulation module 38. The hearing aid simulation module 38 is configured to simulate a virtual hearing aid calibrated according to the results of the performed audiometric test, i.e. the user's hearing loss previously measured by the audiometric test. The simulation of the virtual hearing aid is performed through the audio playback means 14 as output sound source and the audio acquisition means 16 as input sound source.

As mentioned, the virtual hearing aid is calibrated according to the user's hearing loss previously measured by the audiometric test, in order to amplify only the frequencies at which the hearing loss occurs.

In practice, the simulation of the virtual hearing aid allows the user 50 to experience how he/she would hear wearing a customized hearing aid, and to verify the benefits that the hearing aid 60 would bring to the user's hearing ability even before its purchase.

In an embodiment, the hearing aid simulation module 38 makes available to the user 50, through the display means 18 and/or the selection means 20, various basic controls in order to further calibrate the settings, comprising the frequency response curve, of the virtual hearing aid. For example, the basic controls of the virtual hearing aid can comprise a three-band equalizer (low, medium, high) and a volume control. These basic controls allow the user 50 to further customize the virtual hearing aid, making it even more comfortable.

In an embodiment, the hearing aid management group 34 further comprises a hearing aid settings suggestion module 40. The hearing aid settings suggestion module 40 is configured to show to the user 50, through the display means 18 and/or the selection means 20, a value or a color that identify a suggested setting for the calibration of the hearing aid 60, according to the results of the performed audiometric test, i.e. the user's hearing loss previously measured by the audiometric test, in order to amplify only the frequencies at which the hearing loss occurs.

In an embodiment, the hearing aid management group 34 further comprises a hearing aid volume setting module 42. The hearing aid volume setting module 42 is configured to set the volume of the hearing aid 60 according to corresponding commands given by the user 50 through the selection means 20.

In an embodiment, the system 10 for performing an audiometric test and calibrating a hearing aid further comprises a purchase module. The purchase module is configured to allow the user 50 to buy one or more hearing aids. The hearing aids can be bought online, i.e. via ecommerce, or at an authorized dealer. The purchasable hearing aids can be: already calibrated according to the user's hearing loss previously measured by the audiometric test; or not calibrated. In in the latter case, the hearing aid the hearing aid must be calibrated by the user 50 after the purchase, in particular through the hearing aid settings calibration module 36.

In a preferred embodiment, the system 10 for performing an audiometric test and calibrating a hearing aid is a mobile device, for example a smartphone or a tablet, operated by the user 50.

A method for performing an audiometric test and calibrating a hearing aid is described below with reference to FIG. 4.

Initially, the method comprises a step 82 of setting the volume of the system 10 according to corresponding commands given by the user 50 through the selection means 20. This step 82 is performed by the system volume setting module 26 of the audiometric group 24. Preferably, the volume of the system 10 is expressed in dB HL (decibels Hearing Level), a measuring unit of sound intensity that defines to zero the minimum sound pressure value audible to all frequencies.

The method comprises a step 84 of performing an audiometric test of the user hearing, for example following a “start” command given by the user 50 through the selection means 20. This step 84 is performed by the audiometric test module 28 of the audiometric group 24. The audiometric test is performed independently by the system 10 operated by the user 50, i.e. without the intervention of an audiometrist or, more in general, a hearing clinician.

In particular, the step 84 comprises the step of sending a sequence of tones through the audio playback means 14, and the user 50 only has to indicate if he/she hears each of these tones through the selection means 20: for example, touching a “yes” or “I hear” button (tone heard) or a “no” or “I don't hear” button (tone not heard). In a preferred embodiment, the sequence of tones counts five tone frequencies for each ear: 250 Hz, 500 Hz, 1000 Hz, 2000 Hz, and 4000 Hz.

Once the audiometric test of the user 50 is completed, the step 84 comprises the step of saving the results of the performed audiometric test, comprising the user feedbacks or responses, in the local data storage 22 and possibly also in the remote data storage.

In an embodiment, the step 84 comprises the step of visually signaling to the user 50, through the display means 18, each time a tone is sent. In an embodiment, the step 84 comprises the step of visually signaling to the user 50, through the display means 18, when the sequence of tones for the first ear has been sent and it is time to move to the second ear.

In a preferred embodiment, the step of sending a sequence of tones sends the tones to the user 50 (i.e. the listener) following a sequence defined by a predictive algorithm, in order to reduce the duration of the audiometric test by processing user feedbacks or responses. The sequence of tones is defined by a predictive algorithm. The predictive algorithm is based on a psychometric function as follows.

Function response=listener (soundlevel, alpha, beta, gamma, lambda);

wherein:
soundlevel is the value of sound intensity of the tone sent, expressed in dB;
alpha is the personal threshold value of the listener, expressed in dB, i.e. the value of sound intensity to which the listener answers “yes” or “I hear” 50% of the times;
beta is the slope of the psychometric function of the virtual listener;
gamma is a probability representing the possible tendency of the listener to produce false alarms: for example, gamma equal to 0 in order to set a listener without any false alarms;
lambda is a probability representing the possible tendency of the listener to produce attention decreases: for example, lambda equal to 0 in order to set a listener without any attention decreases.

Psychometric function of the observer:

p=gamma+(1−gamma−lambda)*1/(1+exp(beta*(alpha−soundlevel)));

Prediction of the listener response:

prob=rand;

if prob<p then response=1; yes;

else response=0; no;

end;

Note that the above functions are calculated assuming consistent and coherent user/listener feedbacks or responses.

In an embodiment, the method further comprises a step 86 of showing to the user 50 an audiogram or audiometric curve, through the display means 18. This step 86 is performed by the audiogram module 30 of the audiometric group 24. Preferably, the audiogram is shown in real time, i.e. during the performance of the audiometric test. As said, the audiogram is a graphical representation of a person's hearing ability for each ear, indicating the degree and type of hearing loss. In practice, the visualization of the audiogram allows the user 50 to immediately feel his/her level of hearing loss.

In an embodiment, the method further comprises a step 88 of simulating a virtual hearing aid calibrated according to the results of the performed audiometric test, i.e. the user's hearing loss previously measured by the audiometric test. This step 88 is performed by the hearing aid simulation module 38 of the hearing aid management group 34. The simulation of the virtual hearing aid is performed through the audio playback means 14 as output sound source and the audio acquisition means 16 as input sound source.

As mentioned, the virtual hearing aid is calibrated according to the user's hearing loss previously measured by the audiometric test, in order to amplify only the frequencies at which the hearing loss occurs.

In practice, the simulation of the virtual hearing aid allows the user 50 to experience how he/she would hear wearing a customized hearing aid, and to verify the benefits that the hearing aid 60 would bring to the user's hearing ability even before its purchase.

In an embodiment, the step 88 comprises the step of making available to the user 50, through the display means 18 and/or the selection means 20, various basic controls in order to further calibrate the settings, comprising the frequency response curve, of the virtual hearing aid. For example, the basic controls of the virtual hearing aid can comprise a three-band equalizer (low, medium, high) and a volume control. These basic controls allow the user 50 to further customize the virtual hearing aid, making it even more comfortable.

In an embodiment, the method further comprises a step 90 of showing to the user 50, through the display means 18 and/or the selection means 20, a value or a color that identify a suggested setting for the calibration of the hearing aid 60, according to the results of the performed hearing test, i.e. the user's hearing loss previously measured by the audiometric test, in order to amplify only the frequencies at which the hearing loss occurs. This step 90 is performed by the hearing aid settings suggestion module 40 of the hearing aid management group 34.

In an embodiment, the method further comprises a step 92 of purchasing one or more hearing aids by the user 50. This step 92 is allowed by the purchase module. The hearing aids can be bought online, i.e. via ecommerce, or at an authorized dealer. The purchasable hearing aids can be: already calibrated according to the user's hearing loss previously measured by the audiometric test; or not calibrated. In in the latter case, the hearing aid the hearing aid must be calibrated by the user 50 after the purchase, in particular through the hearing aid settings calibration module 36.

The method further comprises a step 94 of calibrating various settings of the hearing aid 60, typically worn by the user 50, according to both the results of the performed audiometric test and the requirements and specifications of hearing aid fitting provided by the manufacturer of the same hearing aid 60. This step 94 is performed by the hearing aid settings calibration module 36 of the hearing aid management group 34.

In an embodiment, the settings of the hearing aid 60 comprises the frequency response curve, the frequencies (for example 500 Hz, 1000 Hz, 2000 Hz, 3000 Hz, and 4000 Hz) and the sound intensity for each frequency expressed in dB HL (for example within a range from 0 to 90).

As mentioned, the hearing aid settings are calibrated according to the user's hearing loss previously measured by the audiometric test, in order to amplify only the frequencies at which the hearing loss occurs.

The calibration of the hearing aid settings can be adjusted over time, for example in case of hearing loss change or for improving the listening of the user 50. Data of each calibration are saved in the local data storage 22.

In an embodiment, the method further comprises a step 96 of setting the volume of the hearing aid 60 according to corresponding commands given by the user 50 through the selection means 20. This step 96 is performed by the hearing aid volume setting module 42 of the hearing aid management group 34.

In the light of the above, it has been ascertained that the system and the method for performing an audiometric test and calibrating a hearing aid according to the present disclosure achieve the intended aim in an effective manner, since it allows the user to perform independently and simply a reliable audiometric test, without the intervention of an audiometrist or, more in general, a hearing clinician.

An advantage of the system and the method for performing an audiometric test and calibrating a hearing aid according to the present disclosure is that they permit the user to configure and calibrate automatically a hearing aid, based on the audiometric test results, without the intervention of an audiologist.

Moreover, an advantage of the system and the method for performing an audiometric test and calibrating a hearing aid according to the present disclosure is that they allow the user to adjust over time the calibration of the hearing aid settings, for example in case of hearing loss change or for improving the listening of the user, simply performing a new audiometric test and a new calibration of the hearing aid settings.

Another advantage of the system and the method for performing an audiometric test and calibrating a hearing aid according to the present disclosure is that they permit the user to obtain a customized hearing aid in a completely independent manner

The disclosure thus devised is susceptible of numerous modifications and variations, all of which are within the scope of the inventive concept; all the details may furthermore be replaced with other technically equivalent elements.

In practice, the materials used, as well as the dimensions, may be any according to the requirements and the state of the art.

One skilled in the art will realize the disclosure may be embodied in other specific forms without departing from the disclosure or essential characteristics thereof. The foregoing embodiments are therefore to be considered in all respects illustrative rather than limiting of the disclosure described herein.

What is claimed is:

1. A system for performing an audiometric test and calibrating a hearing aid, the system being operated by a user and in communication with a hearing aid, the system comprising:
audio playback means, selection means, and a wireless communication module;
an audiometric group, the audiometric group comprising:
a system volume setting module configured to set the volume of the system according to corresponding commands given by the user, through the selection means, and
an audiometric test module configured to perform an audiometric test of the user hearing, sending a sequence of tones, through the audio playback means; and
a hearing aid management group, the hearing aid management group comprising:
a hearing aid settings calibration module configured to calibrate settings of the hearing aid according to both the results of the performed audiometric test and the requirements and specifications of fitting of the hearing aid, calibration data being sent through the wireless communication module to a corresponding wireless communication module comprised in the hearing aid.

2. The system of claim 1, wherein the sequence of tones counts five tone frequencies for each ear: 250 Hz, 500 Hz, 1000 Hz, 2000 Hz, and 4000 Hz.

3. The system of claim 1, wherein the sequence of tones is defined by a predictive algorithm.

4. The system of claim 1, further comprising display means, wherein the audiometric test module visually signals to the user, through the display means, each time a tone is sent.

5. The system of claim 1, further comprising display means, wherein the audiometric test module visually signals to the user, through the display means, when the sequence of tones for the first ear has been sent and it is time to move to the second ear.

6. The system of claim 1, further comprising display means, wherein the audiometric group further comprises an audiogram module configured to show to the user an audiogram or an audiometric curve, through the display means.

7. The system of claim 1, further comprising audio acquisition means, wherein the hearing aid management group further comprises a hearing aid simulation module configured to simulate a virtual hearing aid calibrated according to the results of the performed audiometric test, through the audio playback means as output sound source and the audio acquisition means as input sound source.

8. The system of claim 1, further comprising display means, wherein the hearing aid management group further comprises a hearing aid settings suggestion module configured to show to the user a value or a color that identifies a suggested setting for the calibration of the hearing aid, through the display means and/or the selection means.

9. The system of claim 1, wherein the hearing aid management group further comprises a hearing aid volume setting module configured to set the volume of the hearing aid according to corresponding commands given by the user, through the selection means.

10. The system of claim 1, further comprising a purchase module configured to allow the user to buy one or more hearing aids.

11. A method for performing an audiometric test and calibrating a hearing aid, having a system being operated by a user and in communication with a hearing aid, the method comprising the steps of
setting the volume of the system according to corresponding commands given by the user;
performing an audiometric test of the user hearing, sending a sequence of tones; and
calibrating settings of the hearing aid according to both the results of the performed audiometric test and the requirements and specifications of fitting of the hearing aid.

12. The method of claim 11, wherein the sequence of tones counts five tone frequencies for each ear: 250 Hz, 500 Hz, 1000 Hz, 2000 Hz, and 4000 Hz.

13. The method of claim 11, wherein the sequence of tones is defined by a predictive algorithm.

14. The method of claim 11, wherein the step of performing an audiometric test of the user hearing comprises the step of visually signaling to the user each time a tone is sent.

15. The method of claim 11, wherein the step of performing an audiometric test of the user hearing comprises the step of visually signaling to the user when the sequence of tones for the first ear has been sent and it is time to move to the second ear.

16. The method of claim 11, further comprising the step of showing to the user an audiogram or audiometric curve.

17. The method of claim 11, further comprising the step of simulating a virtual hearing aid calibrated according to the results of the performed audiometric test.

18. The method of claim 11, further comprising the step of showing to the user a value or a color that identifies a suggested setting for the calibration of the hearing aid.

19. The method of claim 11, further comprising the step of setting the volume of the hearing aid according to corresponding commands given by the user.

20. The method of claim 11, further comprising the step of purchasing one or more hearing aids by the user.
